(19) United States
(12) Patent Application Publication
(10) Pub. No.: US 2013/0108038 A1
(43) Pub. Date: May 2, 2013

(54) SYSTEM AND METHOD FOR A COLLATZ BASED HASH FUNCTION

(71) Applicants: Mathieu Ciet, Paris (FR); Augustin J. Farrugia, Cupertino, CA (US); Thomas Icart, Paris (FR)

(72) Inventors: Mathieu Ciet, Paris (FR); Augustin J. Farrugia, Cupertino, CA (US); Thomas Icart, Paris (FR)

(73) Assignee: Apple Inc., Cupertino, CA (US)

(21) Appl. No.: 13/308,452

(22) Filed: Nov. 30, 2011

Related U.S. Application Data
(60) Provisional application No. 61/554,411, filed on Nov. 1, 2011.

(51) Int. Cl. H04L 9/28

(52) U.S. Cl. 380/28

(57) ABSTRACT

Disclosed herein are systems, methods, and non-transitory computer-readable storage media for generating a hash based on the Collatz conjecture. The Collatz conjecture is based on a set of operations for a given number n that are performed iteratively on n, with one operation performed if n is even, and another operation performed if n is odd. Operating on an input value according to the Collatz conjecture for a specified number of iterations produces an output value that can then be used as a hash in a cryptographic function. The hash function performs steps according to the Collatz conjecture, or a modification thereof, on the value n for r iterations, and outputs a resulting hash value. The hash function can apply more complex variations, such as adding multiplication, addition, modulo or other operation(s) in the even and/or odd operations. The hash value can be used to pad blocks of a message.

### CROSS REFERENCE TO RELATED APPLICATIONS

This application claims the benefit of U.S. Provisional Patent Application No. 61/554,411, entitled “SYSTEM AND METHOD FOR A COLLATZ BASED HASH FUNCTION”, filed on Nov. 1, 2011, and which is hereby expressly incorporated herein by reference in its entirety.

### BACKGROUND

1. Technical Field

The present disclosure relates to software security and more specifically to a hash function that can be used in conjunction with cryptography.

2. Introduction

In modern cryptography, one common methodology is the use of mathematical problems that are considered algorithmically hard to solve, in order to give bricks to design strong systems. One such difficult mathematical problem is factorization or the discrete logarithm problem. This approach is very efficient, and was one of the key elements transforming the art of cryptography into a real science. One aspect of the success of basing cryptography on hard problems is mathematically provable levels of security. With some mathematical proof and rigorous analysis, certain security features of a cryptographic scheme can be proven, supposing only that these problems are resistant to attacking algorithms in practice.

Cryptography can include several different components, such as signature, encryption, and hashing. An attacker can more easily unravel, crack, or reverse engineer a cryptographic scheme if he can find a vulnerability in one of those components. Accordingly, any improvements or variations to these components can enhance the security afforded by cryptographic security schemes.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Cryptography generally includes several different components, such as signature, encryption, and hashing. This disclosure is directed to hashing. Specifically, the hashing approaches set forth herein are based on the Collatz conjecture. In 1937, Lothar Collatz introduced a now well-known conjecture. The Collatz conjecture is based on a set of operations for a given number n. FIG. 3 illustrates an example block diagram 300 of the logic behind the Collatz conjecture. For a starting value n 302, a comparison 304 is performed to determine if n is odd or even. If n is even 308, divide n by 2. If n is odd 306, multiply n by 3 and add 1. This cycle then continues with the result from a previous round being the starting point for the next round. Operations are done over the integer space. Given these operations, the Collatz conjecture states that for every positive, non-zero starting integer value, 1 will be reached at some point. When 1 is reached, the series of numbers forms a loop from 1 to 4 to 2 back to 1 again. Some implementations of this algorithm stop when reaching 1. FIG. 2 illustrates an exemplary Collatz conjecture sequence with a starting value of 3 at step 0. 3 is odd, so step 1 shows multiplying 3 by 3 and adding 1 for a value of 10. 10 is even, so step 2 shows dividing 10 by 2 for a value of 5. 5 is odd, so step 3 shows multiplying 5 by 3 and adding 1 for a value of 16. 16 is even, so step 4 shows dividing 16 by 2 for a value of 8. 8 is even, so step 5 shows dividing 8 by 2 for a value of 4. 4 is even, so step 6 shows dividing 4 by 2 for a value of 2. 2 is even, so step 7 shows dividing 2 by 2 for a value of 1. Using the Collatz conjecture, 3 transforms to 1 in 7 steps. FIG. 4 illustrates a longer example 400 of a Collatz conjecture progression with a starting value 402 of 33. The longer example 400 eventually 404 reaches 1, at which point, the progression loops back to 4, 2, 1. Further, the longer progression 400 contains a portion 406 which is the same as shown in FIG. 2. Progressions are more likely to share at least some common path the closer they get to 1.

The progressions of numbers provided by the Collatz conjecture can be applied to generate hashes for use in cryptographic systems. In one simple example, a hash function takes a value n and a value r as input. The hash function performs the Collatz conjecture on the value n for r iterations, and outputs the ending value after r iterations as the hash value. For example, given the simple Collatz conjecture and the input value 402 of 33 as shown in FIG. 4, and an iteration value of 1, the resulting hash value is 100; given an iteration value of 9, the resulting hash value is 88; given an iteration value of 16, the resulting hash value is 26; and so forth. The hash function can apply more complex variations on the basic Collatz conjecture steps, such as multiplying by and/or adding other values, or inserting a modulo operation in one or both of the even and odd operations. Further, bits of the hash value generated based on the Collatz conjecture can be used in padding blocks of a message.

Disclosed are systems, methods, and non-transitory computer-readable storage media for generating hashes based on the Collatz conjecture. An exemplary system receives an input value and an iteration value. For the number of the iteration value, iteratively performing the following steps: if a least significant bit of the input value is 0, dividing the input value by a first value (such as 2), and if a least significant bit of the input value is 1, (1) multiplying the input value by a second value (such as 3), (2) adding one to the input value, and (3) applying a modulo operation of a prime value to the input value, to yield a first iteration value. These steps yield an updated input value for use in a subsequent iteration. Then the system returns the updated input value as a hash value which can be used in a cryptographic function.

In an alternative optimization of the hash function, the system receives an input value and an iteration value, and, based on the iteration value, iteratively performs the following steps: if a least significant bit of the input value is 0, right bit shifting the input value by one bit; if the least significant bit of the input value is 1, and the input value is less than a prime number divided by three, multiplying the input value by 3 and adding 1; if the least significant bit of the input value is 1, and the input value is greater than the prime number divided by 3 and less than 2 times the prime number divided by 3, multiplying the input value by 3, adding 1, and subtracting the prime number; and if the least significant bit of the input value is 1, and the input value is greater than 2 times the prime number divided by 3, multiplying the input value by 3, adding 1, and subtracting 2 times the prime number. These steps produce an updated input value, which the system returns as a hash value.

In a message preparation embodiment, the system receives a message and splits the message into a set of blocks. The system divides each block of the set of blocks into a set of sub-blocks. For each of the set of sub-blocks, the system generates a value based on a hash calculation using values from the set of sub-blocks, and combines the value with a respective one of the set of sub-blocks. Combining the value and the respective one of the set of sub-blocks can include prepending, appending, and otherwise interspersing the value within a particular sub-block. Then the system recombines the set of blocks into a padded message. The hash calculation can be SHA1, SHA2, SHA256, SHA512, a Collatz conjecture based calculation, and/or MD5. Sub-blocks can include one or more reserved portions in to which the value is inserted. For optimization purposes, the size of the value plus a sub-block can be a power of two. These approaches provide a substitute hash algorithm that can provide similar functionality and can be drop-in replacement for virtually any hash function.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a short example of a Collatz conjecture progression;

FIG. 3 illustrates an example block diagram of the logic behind the Collatz conjecture;

FIG. 4 illustrates a longer example of a Collatz conjecture progression;

FIG. 5 illustrates embedding hash values within sub-blocks;

FIG. 6 illustrates an example block diagram of an iterative function to generate a hash based on the Collatz conjecture;

FIG. 7 illustrates a first example method embodiment;

FIG. 8 illustrates a second example method embodiment; and

FIG. 9 illustrates a third example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

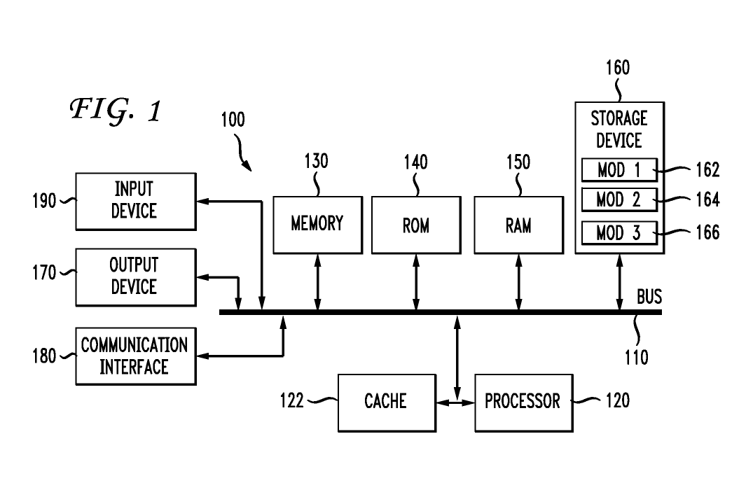

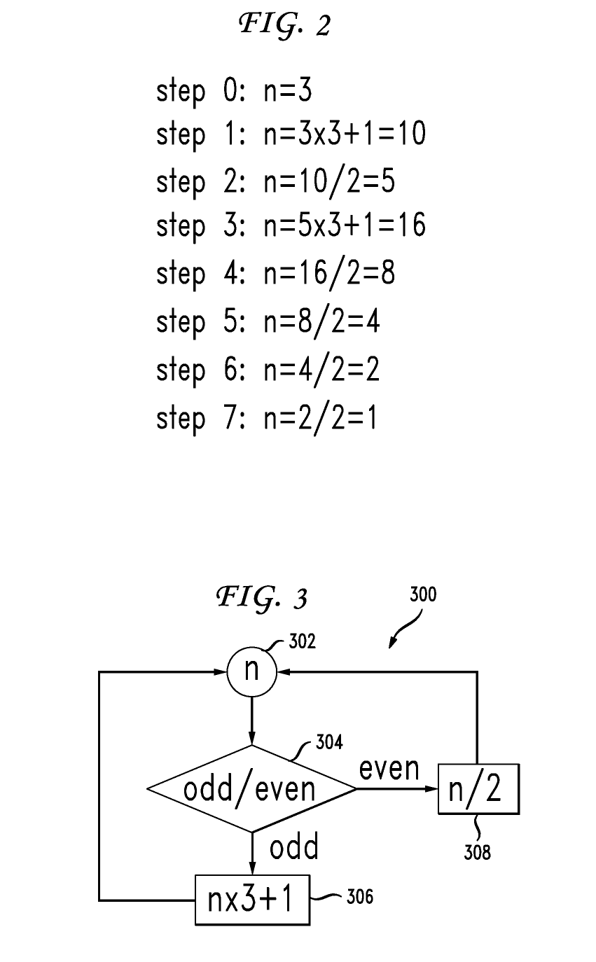

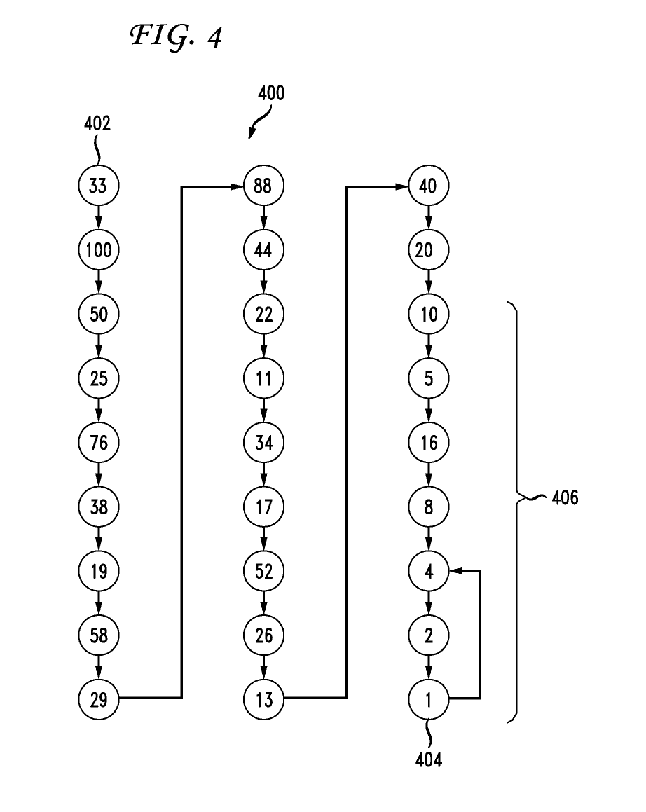

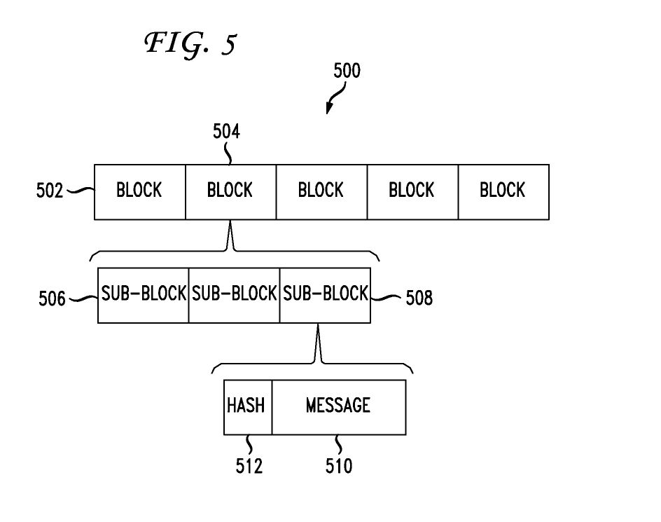

The present disclosure addresses the need in the art for different types of hash functions which can be used in cryptography. A brief introductory description of a basic general purpose system or computing device in FIG. 1 which can be employed to practice the concepts is disclosed herein. A more detailed description of variations of Collatz conjecture based hash functions and uses thereof will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of hashing and related operations based on the Collatz conjecture. The variations set forth herein illustrate different ways to create a hash function based on the Collatz conjecture. In one example, p is a prime, and Cᵣ( ) denotes a generalization of the Collatz function. Given an input value n, the Cᵣ(n) function operates as shown in the pseudo code below for the given input n and a round number r:

```
  set y = n;
  for (i=0 ; i<r ; i++) {
    /* if least significant bit of y is 0 (i.e. even), then halve
the value */
    if ((y&0×01) == 0) then set y = y >> 1; /* where “>>” denotes
a right bit shift */
    /* else y = 3*y+1 mod p (the prime) */
    else set y = (3*y + 1) % p; /*where % denotes a modulo
operation */
  }
  return y;
```

Note all the operations are done in the Galois Field of p (or GF(p)={0, . . . , p−1}), otherwise known as a finite field or a field containing a finite number of discrete elements. For example, the bit shift operation does not need modular specific operation. A different optimization, shown in the pseudo code below, demonstrates steps functionally equivalent to the 3*y+1 operation that can also be performed without a modular specific operation.

if (y < (p-1)/3), then ((3*y+1)%p) = 3*y+1
else if (y < (2p-1)/3), then ((3*y+1)%p) = 3*y+1−p
else ((3*y+1)%p) = 3*y+1−2*p

Thus the 3*y+1 operation can be accomplished using only comparison, right shift and addition operations on potentially very large numbers, which can be a significant computational overhead savings over performing multiplications on such very large numbers. These operations are much less computationally expensive and can facilitate more iterations and/or lower processor cost when generating hashes.

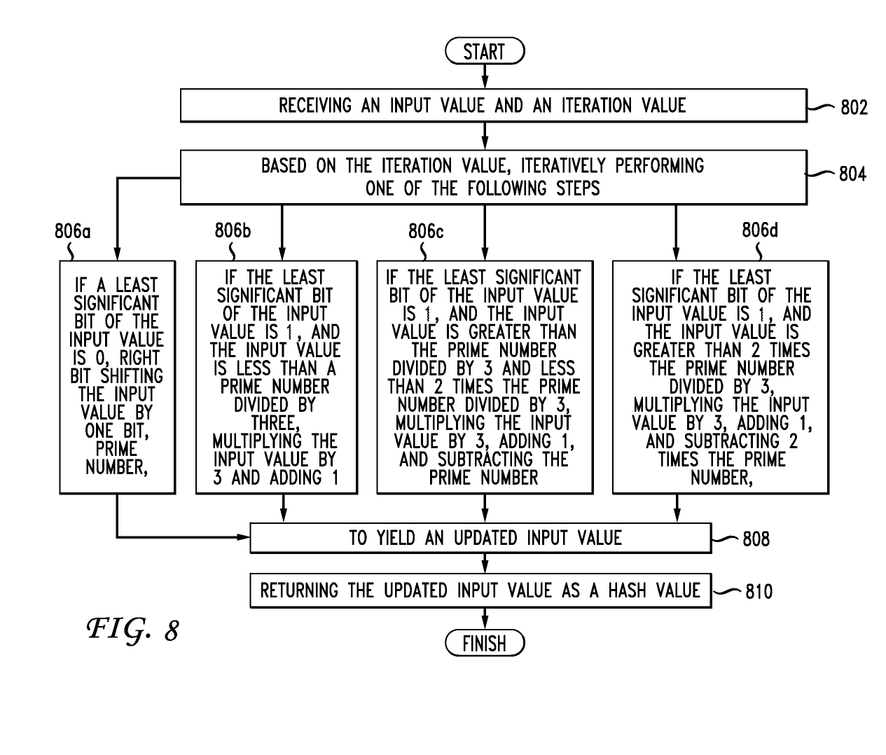

FIG. 8 illustrates an exemplary method embodiment for performing an equivalent of 3*y+1 without modular specific operations, as performed by an exemplary system. The system receives an input value and an iteration value (802). For the indicated number of iterations (804), the system applies one of the following four operations to the input value. If a least significant bit of the input value is 0, the system right bit shifts the input value by one bit (806a). If the least significant bit of the input value is 1, and the input value is less than a prime number divided by three, the system multiplies the input value by 3 and adding 1 (806b). If the least significant bit of the input value is 1, and the input value is greater than the prime number divided by 3 and less than 2 times the prime number divided by 3, the system multiplies the input value by 3, adds 1, and subtracts the prime number (806c). If the least significant bit of the input value is 1, and the input value is greater than 2 times the prime number divided by 3, the system multiplies the input value by 3, adds 1, and subtracts 2 times the prime number (806d). Performing the indicated number of iterations results in an updated input value (808), which can then be returned as a hash value (810).

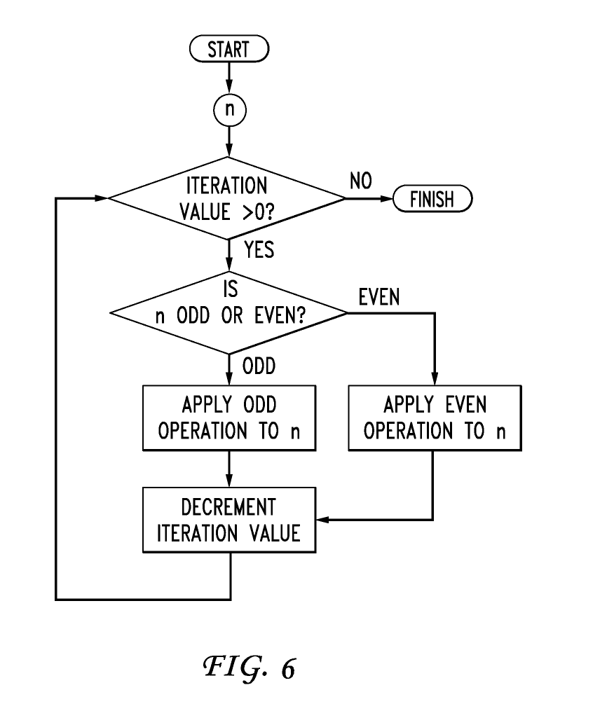

FIG. 6 illustrates an example block diagram of an iterative function to generate a hash based on the Collatz conjecture and variations thereon. Whereas the classic Collatz conjecture divides even numbers by 2 and multiplies odd numbers by 3 and adds 1, the block diagram of FIG. 6 generalizes this approach to include an even operation and an odd operation, which can be extensions of the classic Collatz conjecture operations or can be entirely different operations.

The block diagram begins with an initial value for n and an iteration value indicating how many Collatz conjecture (or related) iterations to apply to n. Thus, if the iteration value is greater than 0, a system implementing the block diagram checks if n is even or odd, such as with a function call or by determining whether the least significant bit of n is a 1 or a 0. If n is even, the system applies an even operation to n. In the classic Collatz conjecture, this operation is a division by 2, but can encompass variations or an entirely different operation. If n is odd, the system applies an odd operation to n. The classic Collatz conjecture multiplies n by 3 and adds 1, but this operation can include other variations as well. Specific variations are set forth throughout this disclosure, some of which include various prime values, modulo operations, and different coefficient values for multiplication operations. After performing the odd or even operation on n, the system decrements the iteration value, and checks if the iteration value is greater than 0. The system can continue with another iteration of checking if n is odd or even, or can finish. While FIG. 6 depicts a loop structure with a decrementing iteration value, this approach can be replaced with any suitable loop or loop equivalent, as will be appreciated by one of skill in the art.

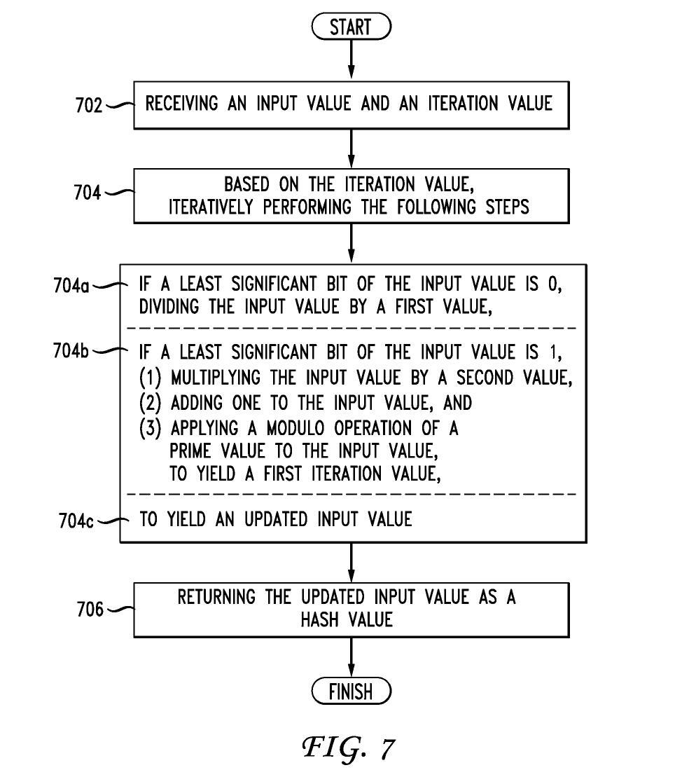

FIG. 7 illustrates an example method embodiment for generating a hash value based on the Collatz conjecture, and is discussed in terms of a system configured to practice the method. The system first receives an input value and an iteration value (702). Then, using the iteration value, the system iteratively implements the Collatz conjecture, in a modified or unmodified form, or implements other operations on the input value (704). If a least significant bit of the input value is 0, the system divides the input value by a first value (704a). In the classic Collatz conjecture, the first value is 2, but can include other values. If the least significant bit of the input value is 1, the system multiplies the input value by a second value, adds one to the input value, and applies a modulo operation of a prime value to the input value (704b), to yield a first iteration value (704c). Then the system continues to perform additional iterations, with each additional iteration using the updated input value from a previous iteration. In the classic Collatz conjecture, the second value is 3, but the system can use other values. Further, in the classic Collatz conjecture, the value of 3 is fixed for each iteration, but the value and/or the operation applied to the input value can change from one iteration to the next, such as by following some established numerical progression or calculation. After performing the indicated number of operations, the system can return the updated input value as a hash value (706). The hash value can then be used in a cryptographic function or operation, such as digital rights management, user or device authentication, encryption, decryption, and so forth. The hash can be used in other types of operations requiring or relying on a hash, such as caching or data storage.

The input value and the number of iterations can be received as part of a function call, in which the output iteration value is a return value for the function call, or these values can be identified in other ways, such as being passed as part of a network-based request. Processing the same input value using the same algorithm for a same number of iterations provides the same resulting hash value.

Another use of the functions set forth herein is padding blocks 504 of a message 502, as set forth in the block diagram 500 of FIG. 5. The block size can be any value, but blocks having a size that is a power of 2, such as 256, 512, or 1024 bits, can be advantageous for computational efficiency. However, the block size can optionally correspond to the hash function and/or prime values used. The system can pad message blocks 504 and/or sub-blocks 506 using the Cᵣ( ) function as set forth above, or a variation thereof. Therefore, an individual sub-block 508 can include a message portion 510 and a hash value portion 512 calculated based on the message portion. The value p is a prime, which can be slightly smaller than 2³² on a 32-bit computing device, slightly smaller than 2⁶⁴ on a 64-bit computing device, or some other sufficiently large prime number to achieve the desired results of performance and/or security, while maintaining p<(2³²+2)/3, or p<(2⁶⁴+2)/3, respectively. The prime p change for each Cᵣ( ) invocation and/or iteration Likewise, the number of iterations can change for each Cᵣ( ) invocation.

The system receives a message to pad. The message can include any quantity and type of data. In this example, each of the resulting padded blocks of the message will be 512 bits, of which 448 bits are message, and 64 bits are a hash value. Other ratios of message data to hash value can be used as well. The system determines a size of a message m, and pads, if necessary, the message m with 0s, 1s, or some pattern of 1s and 0s to make the size a multiple of 448 bits. Then, the system divides the message m into a set of 448-bit blocks, M. For each block M, the system decomposes M into 32-bit or 64 bit blocks Mᵢ. For i in 0 to 1, the system (1) computes a temporary_value by M_{(0+7*i)}+M_{(1+7*i)}+M_{(6+7*i)}, (2) computes val=Cᵣ(temporary_value), and (3) combines val to M. The system can combine val with M via prepending, appending, or other combination, such as by interspersing different strings of bits of val within M at predetermined locations. After performing this operation on the blocks M, the system recomposes the blocks M into a new message m. Thus, the new message m is larger than the original message m. Hash values for each block M can be generated based on the contents of the respective block M. Then the hashing function can be used classically, such as using SHA1 or SHA2.

In another variation, the system receives a message to pad with hash values, and splits the message into a set of blocks. For each block of the set of blocks, the system divides each block into a set of sub-blocks. For each of the set of sub-blocks, the system (1) generates a value based on a hash calculation using values from the set of sub-blocks, and combines the value with a respective one of the set of sub-blocks. Then the system recombines the set of sub-blocks and the set of blocks into a padded message. The hash calculation can include SHA1, SHA2, SHA256, SHA512, a Collatz conjecture based calculation, and/or MD5. The sub-blocks can include a reserved portion in to which the value is inserted.

The hash function can implement an extension of the Cᵣ( ) function denoted Cᵣ,p1,p2( ), where p1 and p2 are prime values. Exemplary pseudo code for the function Cᵣ,p1,p2( ), is set forth below:

```
  set y = x;
  for (i=0 ; i<r ; i++) {
    /* if the least significant bit of y is 0 (i.e. it’s even),
then halve the value + p1 mod p */
    if ((y&0×01)== 0) then set y = (y >> 1) + p1 % p; /* where “>>”
denote the right shift */
    /* else y = 3*y+p2 mod p */
    else set y = (3*y + p2) % p; /*where % denote the modulo
operation */
  }
  return y;
```

where p1 and p2 are two prime numbers part of the definition of the hash function. P1 and p2 can also be used for padding, as before.

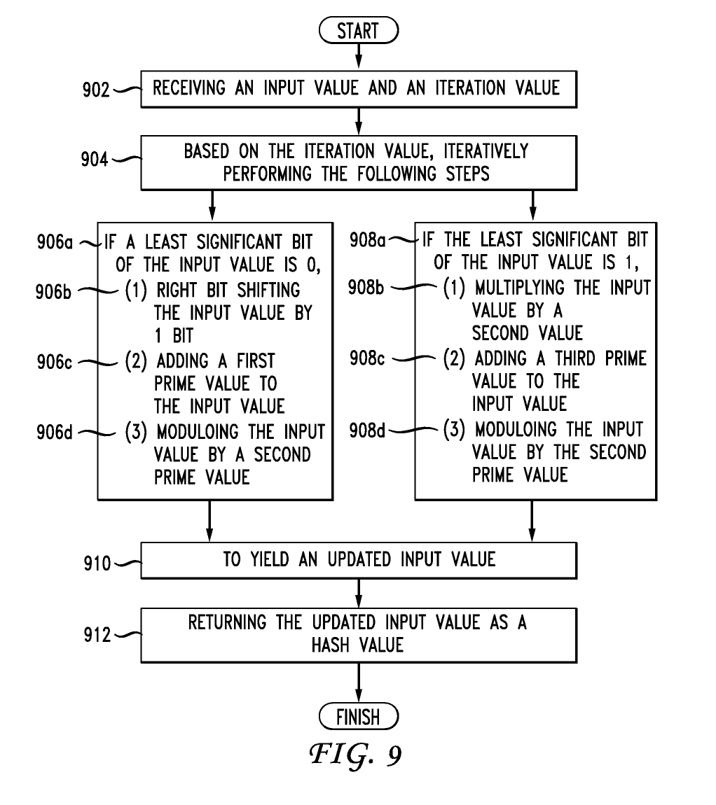

FIG. 9 illustrates a variation method embodiment involving prime numbers that corresponds to the algorithm set forth in the pseudo code above. The system receives an input value and an iteration value (902), as above. Then, the system performs multiple iterations on the input value according to the received iteration value (904). In each iteration, if a least significant bit of the input value is 0 (906a), the system right bit shifts the input value by 1 bit (906b), adds a first prime value to the input value (906c), and applies a modulus operation on the input value by a second prime value (906d). In other words, these steps extend the classical Collatz conjecture for an even value n (i.e. n=n/2) as shown by n=(n/2)+first prime value % second prime value. If the least significant bit of the input value is 1 (908a), the system multiplies the input value by a second value (908b), adds a third prime value to the input value (908c), and applies a modulus operation to the input value by the second prime value (908d). These steps extend the classical Collatz conjecture for an odd value (i.e. n=n*3+1) as shown by n=(3*n+third prime value) % second prime value.

A set number of iterations of these steps to the input value yields an updated input value (910) which can be returned in response to a function call (912). The first prime value, the second prime value, and the third prime value can be passed as parameters or variables to the function, or can be incorporated as part of the function. The second prime value can be any prime number, but can optionally correspond to the block size. For example, if the block size is 512 bits, then the second prime can be smaller than 2⁵¹². The updated input value can be used in padding 512 bit sub-blocks of a message m.

In a hash scheme, p can be a defined prime internally used, and smaller than 2⁵¹², in Cᵣ,p1,p2( ) m can be a message to be hashed. The hash operation is defined as follows:

```
  Pad m to obtain a length in bit multiple of 512 (prepend with 01 and
a set of 0s), resulting in M
  Decompose M into 512-bit blocks {Mᵢ}ᵢ
  Set Acc = M₀
  For i from 0 to the last block
    Compute tmp = Cᵣ,p1,p2(Mᵢ)
    Update Acc as (Acc XOR tmp) % 2⁵¹²
  Return H = Acc % 2²⁵⁶ /* H is the value at the end of the hash
function defined after the Collatz conjecture */
```

The hash functions set forth herein incorporate computations based on a modification to the Collatz conjecture that achieves sufficient security for cryptographic usage.

The exemplary method embodiments shown in FIGS. 7-9 are discussed in terms of an exemplary system 100 as shown in FIG. 1 configured to practice the respective methods. The steps outlined herein are exemplary and can be implemented in any combination thereof, including combinations that exclude, add, reorder, or modify certain steps. These exemplary method figures refer to iterative processes, but do not show the steps of each iteration separately.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving an input value and an iteration value;
based on the iteration value, iteratively performing steps comprising:
if a least significant bit of the input value is 0,
(1) dividing the input value by a first value,
if a least significant bit of the input value is 1,
(1) multiplying the input value by a second value,
(2) adding one to the input value, and
(3) applying a modulo operation of a prime value to the input value, to yield a first iteration value,
to yield an updated input value;
returning the updated input value as a hash value.

2. The method of claim 1, wherein the first value is 2 and the second value is 3.

3. The method of claim 1, wherein the hash value is used in a cryptographic function.

4. The method of claim 1, wherein a first iteration operates on the input value, and subsequent iterations operate on the updated input value from an immediately previous iteration.

5. A method comprising:
receiving an input value and a number of iterations;
for the number of iterations, performing steps comprising:
on a first iteration, if a least significant bit of the input value is 0, dividing the input value by a first value, else multiplying the input value by the second value, adding one to the input value, and applying a modulo operation of a prime value to the input value, to yield a first iteration value;
on subsequent iterations, if the least significant bit of an immediately previous iteration value is 1, dividing the input value by the first value, else multiplying the immediately previous iteration value by the second value, adding one to the immediately previous iteration value, and applying the modulo operation of the prime value to the immediately previous iteration value, to yield a modified iteration value; and
returning an output iteration value from the number of iterations as a hash value.

6. The method of claim 5, wherein the hash value is used in a cryptographic function.

7. The method of claim 5, wherein the input value and the number of iterations are received as part of a function call.

8. The method of claim 7, wherein the output iteration value is a return value for the function call.

9. The method of claim 5, wherein the first value is 2, and wherein dividing the input value by the first value comprises right bit shifting the input value by 1 bit.

10. A system comprising:
a processor;
a memory storing instructions for controlling the processor to perform steps comprising:
receiving an input value and an iteration value;
based on the iteration value, iteratively performing steps comprising:
if a least significant bit of the input value is 0,
(1) right bit shifting the input value by 1 bit,
(2) adding a first prime value to the input value, and
(3) moduloing the input value by a second prime value, and
if the least significant bit of the input value is 1,
(1) multiplying the input value by a second value,
(2) adding a third prime value to the input value, and
(3) moduloing the input value by the second prime value, to yield an updated input value; and
returning the updated input value in response to a call to a function.

11. The system of claim 10, wherein the first prime value and the third prime value are included in the function.

12. The system of claim 10, wherein the second prime value is passed as a parameter to the function.

13. The system of claim 10, wherein the second prime value is a predefined value.

14. The system of claim 10, wherein the second prime value is larger than 2⁵¹².

15. The system of claim 14, wherein the updated input value is used in padding 512 bit sub-blocks of a message m.

16. The system of claim 10, wherein the updated input value is used in a cryptographic function.

17. A non-transitory computer-readable storage medium storing instructions which, when executed by a computing device, cause the computing device to perform steps comprising:
receiving a message;
splitting the message into a plurality of blocks;
for each block of the plurality of blocks, performing steps comprising:
dividing each block into a plurality of sub-blocks;
for each of the plurality of sub-blocks, performing steps comprising:
generating a value based on a hash calculation using values from the plurality of sub-blocks, and
combining the value with a respective one of the plurality of sub-blocks; and
recombining the plurality of blocks into a padded message.

18. The non-transitory computer-readable storage medium of claim 17, wherein padding comprises at least one of appending and prepending the respective one of the plurality of hash values to a block.

19. The non-transitory computer-readable storage medium of claim 17, wherein the hash calculation comprises at least one of SHA1, SHA2, SHA256, SHA512, a Collatz conjecture based calculation, and MD5.

20. The non-transitory computer-readable storage medium of claim 17, wherein each of the plurality of sub-blocks includes a reserved portion in to which the value is inserted.

21. The non-transitory computer-readable storage medium of claim 20, wherein a size of the value and one of the plurality of sub-blocks is a power of two.

22. A system comprising:
a processor;
a memory storing instructions for controlling the processor to perform steps comprising:
receiving an input value and an iteration value;
based on the iteration value, iteratively performing steps comprising:
if a least significant bit of the input value is 0, right bit shifting the input value by one bit,
if the least significant bit of the input value is 0, and the input value is less than a prime number divided by three, multiplying the input value by 3 and adding 1,
if the least significant bit of the input value is 0, and the input value is greater than the prime number divided by 3 and less than 2 times the prime number divided by 3, multiplying the input value by 3, adding 1, and subtracting the prime number,
if the least significant bit of the input value is 0, and the input value is greater than 2 times the prime number divided by 3, multiplying the input value by 3, adding 1, and subtracting 2 times the prime number,
to yield an updated input value;
returning the updated input value as a hash value.

23. The system of claim 22, wherein the hash value is used in a cryptographic function.
